(19) United States
(12) Patent Application Publication
(10) Pub. No.: US 2022/0138478 A1
(43) Pub. Date: May 5, 2022

(54) SELF MINING MACHINE SYSTEM WITH AUTOMATED CAMERA CONTROL FOR OBSTACLE TRACKING

(71) Applicant: Joy Global Surface Mining Inc, Milwaukee, WI (US)

(72) Inventors: Keshad Darayas Malegam, Milwaukee, WI (US); Wesley P. Taylor, Glendale, WI (US)

(21) Appl. No.: 17/518,346

(22) Filed: Nov. 3, 2021

Related U.S. Application Data
(60) Provisional application No. 63/109,153, filed on Nov. 3, 2020.

(51) Int. Cl. G06K 9/00; H04N 5/232

(52) U.S. Cl. CPC G06K 9/00805; H04N 5/23299; H04N 5/23218

(57) ABSTRACT

A system for detecting an obstacle within a vicinity of a mining machine and providing automated camera control. The system includes at least one proximity sensor associated with the mining machine and a camera associated with the mining machine. The system also includes an electronic processor communicatively coupled to the at least one proximity sensor and the camera. The electronic processor is configured to receive data from the at least one proximity sensor. The electronic processor is also configured to determine a location of at least one obstacle based on the data. The electronic processor is also configured to determine at least one camera parameter based on the location of the at least one obstacle and control the camera using the at least one camera parameter.

### CROSS-REFERENCE TO RELATED APPLICATIONS

This application claims priority to U.S. Provisional Application No. 63/109,153, filed on Nov. 3, 2020, which is incorporated herein by reference in its entirety.

### FIELD

Embodiments described herein relate to a mining machine system with automated camera control for obstacle tracking.

### SUMMARY

Some camera systems onboard heavy machinery (for example, mining machines such as a blasthole drill, rope shovel, or the like) consist of either multiple fixed field-of-view cameras in various locations or pan and tilt cameras that require operator input to provide the operator with situational awareness, or a combination of fixed field-of-view cameras and pan/tilt cameras. In the event that the machine is equipped with an obstacle detection system (“ODS”) (for example, to detect nearby people, equipment, or other obstacles), the operator may be alerted to the presence of an obstacle. However, the operator will have to either manually locate the obstacle (for example, across video feeds from multiple cameras), manually control one or more of the cameras to locate the obstacle, or a combination thereof. Among other things, this system results in potential loss of production (or downtime) while the obstacle is manually located by an operator.

Accordingly, some embodiments described herein provide methods and systems that automate the process of locating a potential obstacle and provide an operator immediate feedback. For example, some embodiments provide an object detection system (for example, using one or more proximity sensors) that detects an obstacle and automatically, based on that detection, controls a camera (for example, a pan-tilt-zoom camera or a fixed view camera) to pan and tilt to the detected obstacle. Additionally, some embodiments described herein automatically control the camera such that the obstacle remains within a field of view of the camera (for example, in the event that the obstacle and/or the mining machine moves). Therefore, embodiments described herein provide immediate visual feedback to operators, and, thus, reduce downtime and improve situation awareness of the operator.

One embodiment provides a system for detecting an obstacle within a vicinity of a mining machine and providing automated camera control. The system includes at least one proximity sensor associated with the mining machine and a camera associated with the mining machine. The system also includes an electronic processor communicatively coupled to the at least one proximity sensor and the camera. The electronic processor is configured to receive data from the at least one proximity sensor. The electronic processor is also configured to determine a location of at least one obstacle based on the data. The electronic processor is also configured to determine at least one camera parameter based on the location of the at least one obstacle and control the camera using the at least one camera parameter.

Another embodiment provides a method for detecting at least one obstacle within a vicinity of a mining machine and providing automated camera control. The method includes receiving, with an electronic processor, data from a proximity sensor. The method also includes determining, with the electronic processor, a location of the at least one obstacle based on the data received from the proximity sensor. The method also includes determining, with the electronic processor, at least one camera parameter based on the location of the at least one obstacle. The method also includes controlling, with the electronic processor, a camera associated with the mining machine using the at least one camera parameter to maintain the at least one obstacle within a field of view of the camera.

Another embodiment provides a system for detecting an obstacle within a vicinity of a mining machine and providing automated camera control. The system includes at least one camera associated with the mining machine. The camera is configured to sense obstacles located near the mining machine. The system also includes an electronic processor communicatively coupled to the at least one camera. The electronic processor is configured to receive data from the at least one camera. The electronic processor is also configured to determine location of at least one obstacle based on the data. The electronic processor is also configured to determine at least one camera parameter based on the location of the at least one obstacle and control the camera using the at least one camera parameter to maintain the at least one obstacle within a field of view of the camera.

Another embodiment provides a system for detecting an obstacle within a vicinity of a mining machine and providing automated camera control. The system includes at least one proximity sensor associated with the mining machine. The system also includes a first camera and a second camera associated with the mining machine. Additionally, the system includes an electronic processor communicatively coupled to the at least one proximity sensor, the first camera, and the second camera. The electronic processor is configured to receive data from the at least one proximity sensor. The electronic processor is also configured to determine a location of at least one obstacle based on the data. The electronic processor is also configured to determine that the location of the at least one obstacle is in a field of view of the first camera and provide the video feed from the first camera on a display device associated with the mining machine.

Other aspects of the embodiments will become apparent by consideration of the detailed description and accompanying drawings.

### BRIEF DESCRIPTION OF THE DRAWINGS

FIG. 1 illustrates a mining machine according to some embodiments.

FIG. 2 illustrates a mining machine according to some embodiments.

FIG. 3 schematically illustrates a system for providing automated camera control for a mining machine according to some embodiments.

FIG. 4A schematically illustrates a controller of the system of FIG. 3 according to some embodiments.

FIG. 4B schematically illustrates a camera of the system of FIG. 3 according to some embodiments.

FIG. 5 is a flowchart illustrating a method for providing automated camera control for a mining machine performed by the system of FIG. 3 according to some embodiments.

FIG. 6 schematically illustrates an obstacle within a vicinity of a mining machine according to some embodiments.

FIG. 7 schematically illustrates two obstacles within a vicinity of the mining machine according to some embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (for example, stored on non-transitory computer-readable medium) executable by one or more electronic processors, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” and the like, described in the specification can include one or more electronic processors, one or more computer-readable medium modules, one or more input/output interfaces, and various connections (for example, a system bus) connecting the components.

Relative terminology, such as, for example, “about,” “approximately,” “substantially,” and the like, used in connection with a quantity or condition would be understood by those of ordinary skill to be inclusive of the stated value and has the meaning dictated by the context (for example, the term includes at least the degree of error associated with the measurement accuracy, tolerances (for example, manufacturing, assembly, use, and the like) associated with the particular value, and the like). Such terminology should also be considered as disclosing the range defined by the absolute values of the two endpoints. For example, the expression “from about 2 to about 4” also discloses the range “from 2 to 4.” The relative terminology may refer to plus or minus a percentage (for example, 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

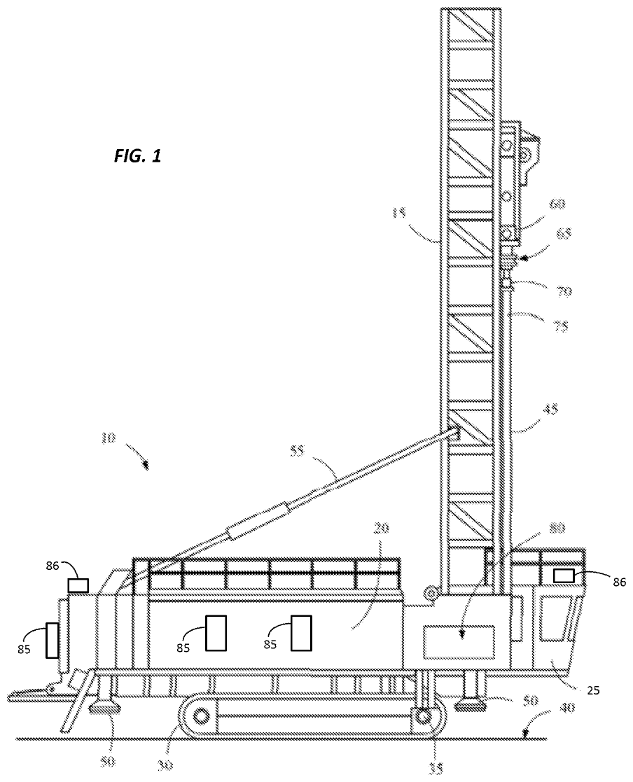

FIG. 1 illustrates a blasthole drill 10 that includes a drill tower 15, a base 20 (for example, a machinery house) beneath the drill tower 15 that supports the drill tower 15, an operator cab 25 coupled to the base 20, and crawlers 30 driven by a crawler drive 35 that drives the blasthole drill 10 along a ground surface 40. The blasthole drill 10 also includes a drill pipe 45 configured to extend downward (for example, vertically) through the ground surface 40 and into a borehole. In some constructions, multiple drill pipes 45 are connected together to form an elongated drill string that extends into the borehole. The blasthole drill 10 also includes leveling jacks 50 coupled to the base 20 that support the blasthole drill 10 on the ground surface 40, and a brace 55 coupled to both the base 20 and the drill tower 15 that supports the drill tower 15 on the base 20. The drill tower 15 includes a drill head motor 60 coupled to the drill tower 15 that drives a drill head 65 and a coupling 70 that couples together the drill head 65 with an upper end 75 of the drill pipe 45. The blasthole drill 10 also includes a bit changer assembly 80 that manually or autonomously exchanges a drill bit on a lower end of the drill pipe 45. The bit changer assembly 80 also stores inactive drill bits during operation of the blasthole drill 10. Other constructions of the blasthole drill 10 do not include, for example, the operator cab 25, the brace 55, or one or more other components as described above. The blasthole drill 10 also includes one or more proximity sensors 85 positioned around (or on) the drill 10 at various locations. The proximity sensors 85 detect an object or obstacle (for example, a person, a piece of equipment, another mining machine, a vehicle, or the like) in the vicinity of the blasthole drill 10, as described in further detail below. The vicinity of the mining machine refers to, for example, the area around the drill 10 within a predetermined distance from the outer surfaces of the mining machine, the area around the drill 10 within a predetermined distance from a center point or other selected point of the mining machine, or the area around the drill 10 within sensing range of the proximity sensor 85. In some embodiments, the proximity sensor 85 may include at least one of light detection and ranging (“lidar”) sensor, a radar sensor, and a camera. Additionally, the blasthole drill 10 includes one or more cameras 86 positioned around (or on) the drill 10 at various locations. The cameras 86 may be pan-tilt-zoom (“PTZ”) cameras configured to capture an image or video stream around the mining machine, including, for example, an obstacle in the vicinity of the blasthole drill 10, as described in further detail below. In some embodiments, the cameras 86 may be fixed field cameras configured to capture an image or video stream around the mining machine, including, for example, an obstacle in the vicinity of the blasthole drill 10. In some embodiments, the cameras 86 may be a combination of PTZ cameras and fixed field cameras.

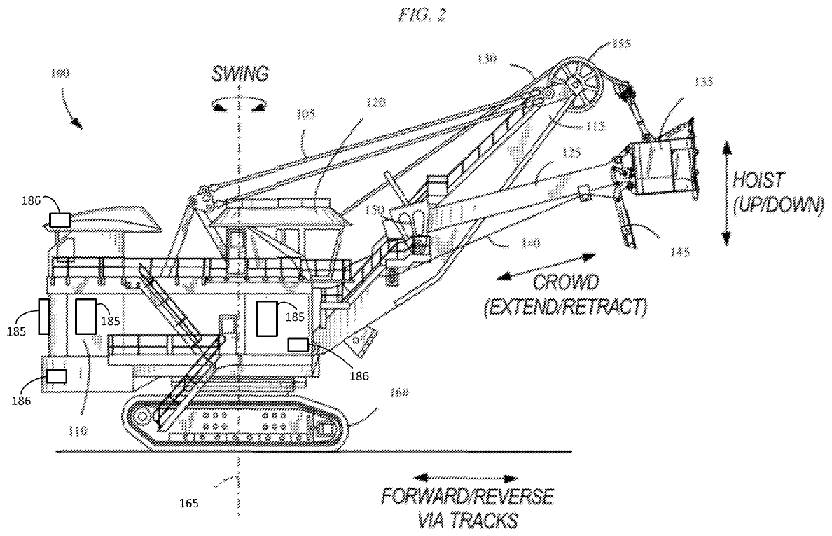

FIG. 2 illustrates a rope shovel 100 that includes suspension cables 105 coupled between a base 110 and a boom 115 for supporting the boom 115, an operator cab 120, and a dipper handle 125. The rope shovel 100 also includes a wire rope or hoist cable 130 that may be wound and unwound within the base 110 to raise and lower an attachment or dipper 135, and a trip cable 140 connected between another winch (not shown) and the door 145. The rope shovel 100 also includes a saddle block 150 and a sheave 155. The rope shovel 100 uses four main types of movement: forward and reverse, hoist, crowd, and swing. Forward and reverse moves the entire rope shovel 100 forward and backward using the tracks 160. Hoist moves the attachment 135 up and down. Crowd extends and retracts the attachment 135. Swing pivots the rope shovel 100 around an axis 165. Overall movement of the rope shovel 100 utilizes one or a combination of forward and reverse, hoist, crowd, and swing. Other constructions of the rope shovel 100 do not include, for example, the operator cab 120 or one or more other components as described above. The rope shovel 100 also includes one or more proximity sensors 185 positioned around the shovel 100 at various locations. The proximity sensors 185 detect an object or obstacle (for example, a person, a piece of equipment, another mining machine, a vehicle, or the like) in the vicinity of the rope shovel 100, as described in further detail below. The vicinity of the mining machine refers to, for example, the area around the rope shovel 100 within a predetermined distance from the outer surfaces of the mining machine, the area around the rope shovel 100 within a predetermined distance from a center point or other selected point of the mining machine, or the area around rope shovel 100 within sensing range of the proximity sensors 185. Additionally, the shovel 100 includes one or more cameras 186 positioned around (or on) the shovel 100 at various locations. The cameras 186 may be PTZ cameras, fixed field camera, or a combination of the two configured to capture an image or video stream around the mining machine, including, for example, an object in the vicinity of the shovel 100, as described in further detail below.

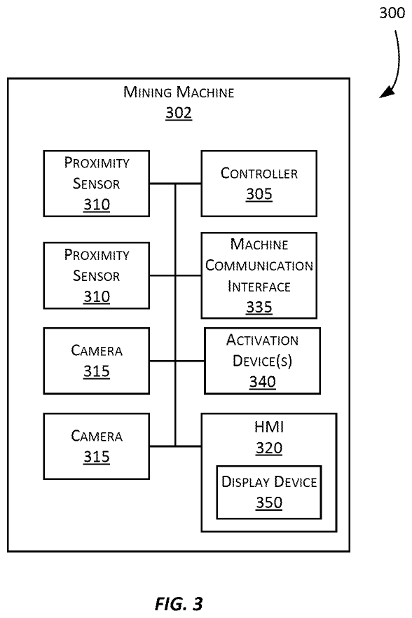

FIG. 3 schematically illustrates a system 300 of automated camera control for a mining machine 302 according to some embodiments. Although the methods and systems described herein are described with reference to a mining machine 302 (a type of industrial machine) (for example, the blasthole drill 10 of FIG. 1, the rope shovel 100 of FIG. 2, or another mining machine), in some embodiments, the systems and methods described herein are for use with other (non-mining) types of mobile industrial machines, such as construction equipment (for example, a crane), a ship, or the like.

As illustrated in FIG. 3, the system 300 includes a controller 305, one or more proximity sensors 310 (collectively referred to herein as “the proximity sensors 310” and individually as “the proximity sensor 310”) (for example, the proximity sensors 85 of the drill 10 (FIG. 1) or the proximity sensors 185 of the rope shovel 100 (FIG. 2)), one or more cameras 315 (collectively referred to herein as “the cameras 315” and individually as “the camera 315”) (for example, the cameras 86 of the drill 10 (FIG. 1) or the cameras 186 of the rope shovel 100 (FIG. 2)), a human machine interface (“HMI”) 320, and a machine communication interface 335 associated with the mining machine 302. In some embodiments, the system 300 includes fewer, additional, or different components than those illustrated in FIG. 3 in various configurations and may perform additional functionality than the functionality described herein. For example, in some embodiments, the system 300 includes multiple controllers 305, HMIs 320, machine communication interfaces 335, or a combination thereof. Additionally, the system 300 may include any number of proximity sensors 310 and/or cameras 315 and the two proximity sensors and cameras illustrated in FIG. 3 are purely for illustrative purposes. Also, in some embodiments, one or more of the components of the system 300 may be distributed among multiple devices, combined within a single device, or a combination thereof. The system 300 further includes one or more activation devices 340 (referred to herein collectively as “the activation devices 340” or individually as “the activation device 340”). Alternatively or in addition, in some embodiments, the system 300 includes other components associated with the mining machine 302, such as one or more actuators, motors, pumps, indicators, and the like, for example, to control the hoist, crowd, swing, and forward-reverse motions.

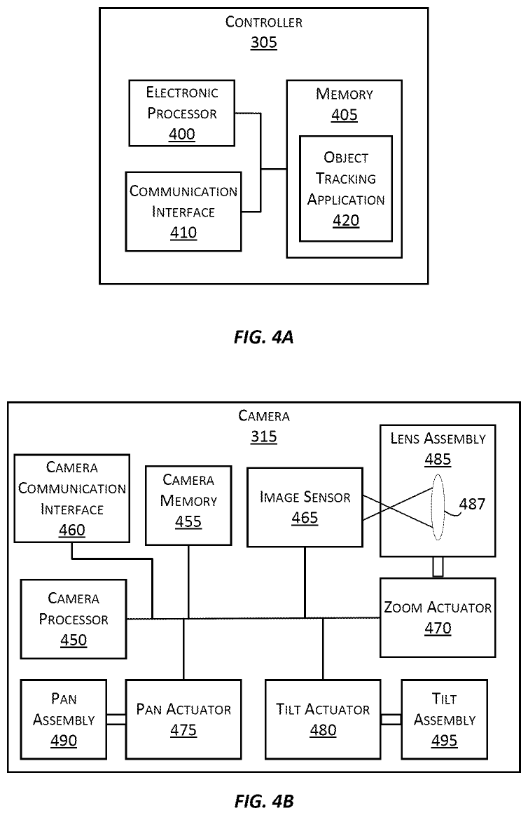

In the example illustrated in FIG. 4A, the controller 305 includes an electronic processor 400 (for example, a microprocessor, an application specific integrated circuit, or another suitable electronic device), a memory 405 (for example, one or more non-transitory computer-readable storage mediums), and an communication interface 410. The electronic processor 400, the memory 405, and the communication interface 410 communicate over one or more data connections or buses, or a combination thereof. The controller 305 illustrated in FIG. 4A represents one example, and, in some embodiments, the controller 305 includes fewer, additional, or different components in different configurations than illustrated in FIG. 4A. Also, in some embodiments, the controller 305 performs functionality in addition to the functionality described herein.

The communication interface 410 allows the controller 305 to communicate with devices external to the controller 305. For example, as illustrated in FIG. 3, the controller 305 may communicate with one or more of the proximity sensors 310, one or more of the cameras 315, the HMI 320, the machine communication interface 335, one or more of the activation devices 340, another component of the system 300 and/or mining machine 302, or a combination thereof through the communication interface 410. The communication interface 410 may include a port for receiving a wired connection to an external device (for example, a universal serial bus (“USB”) cable and the like), a transceiver for establishing a wireless connection to an external device (for example, over one or more communication networks, such as the Internet, LAN, a WAN, and the like), or a combination thereof.

The electronic processor 400 is configured to access and execute computer-readable instructions (“software”) stored in the memory 405. The software may include firmware, one or more applications, program data, filters, rules, one or more program modules, and other executable instructions. For example, the software may include instructions and associated data for performing a set of functions, including the methods described herein. As illustrated in FIG. 4A, the memory 405 includes an obstacle tracking application 420, which is an example of such software. The obstacle tracking application 420 is a software application executable by the electronic processor 400 to perform obstacle tracking with respect to an obstacle detected within the vicinity of the mining machine 302. For example, in some embodiments, the electronic processor 400, executing the obstacle tracking application 420, detects and tracks an obstacle within the vicinity of the mining machine 302 (based on obstacle data collected by the proximity sensors 310) and automatically controls one or more of the cameras 315 to, for example, pan and tilt to the detected obstacle (such that the obstacle is positioned within the field of view of the camera 315). As another example of controlling the one or more cameras 315, the electronic processor 400, executing the obstacle tracking application 420, may perform a combination of panning and tilting to the detected obstacle and switching between video feeds of one or more cameras 315 to maintain the detected obstacle in the field of view of at least one of the one or more cameras 315 as displayed on a video feed.

As another example, in some embodiments, the electronic processor 400, executing the obstacle tracking application 420, detects and tracks an obstacle within the vicinity of the mining machine 302 (based on obstacle data collected by the proximity sensors 310 and/or one or more cameras 315) and automatically control a video feed of one or more cameras 315 to, for example, display the detected obstacle (such that the obstacle is positioned within the video feed of a camera of the one or more cameras 315). In some embodiments, the obstacle tracking application 420 may apply image processing to the video feed of the one or more cameras 315. For example, image processing may include at least one of zooming in on the detected obstacle (for example, expanding video feed pixels to display the detected obstacle) and cropping the video feed (for example, cropping the extraneous portion of the video feed captured by the camera). In some embodiments, image processing may be used by the obstacle tracking application 420 to determine that an obstacle is present in a video feed of the one or more cameras 315. For example, the obstacle tracking application 420 may determine that the obstacle does not typically belong in a field of view of the one or more cameras 315.

The proximity sensors 310 detect and track an obstacle within a vicinity of the mining machine 302. As noted above, an obstacle may include, for example, a person, a vehicle (such as a haul truck), equipment, another mining machine, and the like. As also noted above, the vicinity of the mining machine 302 refers to, for example, the area around the mining machine 302 within a predetermined distance from the outer surfaces of the mining machine 302, the area around the mining machine 302 within a predetermined distance from a center point or other selected point of the mining machine 302, or the area around the mining machine 302 within sensing range of the proximity sensors 310. The proximity sensors 310 may be positioned on (or mounted to) the mining machine 302 at various positions or locations around the mining machine 302. Alternatively, or in addition, the proximity sensors 310 may be positioned external to the mining machine 302 at various positions or locations around the mining machine 302.

The proximity sensors 310 may include, for example, radar sensors, lidar sensors, infrared sensors (for example, a passive infrared (“PIR”) sensor), a camera and the like. As one example, in some embodiments, the proximity sensors 310 are cameras, and in some embodiments the one or more cameras 315 may include the proximity sensors 310. Cameras may capture video feed of their field of view and the video feed may be processed using image processing to determine an object that is an obstacle is present in the field of view of the camera. As another example, in some embodiments, the proximity sensors 310 are lidar sensors. Lidar sensors emit light pulses and detect objects based on receiving reflections of the emitted light pulses reflected by the objects. More particularly, when emitted light pulses reach a surface of an object, the light pulses are reflected back towards the lidar sensor, which senses the reflected light pulses. Based on the emitted and received light pulses, the lidar sensor(s) (for example, the proximity sensors 310) may determine a distance between the lidar sensor and the surface (or, in the absence of reflected light pulses, determine that no object is present). For example, the lidar sensor(s) (as the proximity sensors 310) may include a timer circuit to calculate a time of flight of a light pulse (from emission to reception), and then to divide the time of flight by the speed of light to determine a distance from the surface. In other embodiments, wavelengths of a received light pulse are compared to a reference light pulse to determine a distance between the lidar sensor and the surface. Alternatively, or in addition, in some embodiments, the lidar sensor(s) (as the proximity sensors 310) determine a horizontal angle between the lidar sensor and the surface, a vertical angle between the lidar sensor and the surface, or a combination thereof. In such embodiments, the lidar sensor(s) perform a scan of an area surrounding the mining machine 302 (for example, scanning left to right and up to down). As one example, the lidar sensor(s) may start with an upper left position and scan towards a right position. After scanning as far right as possible, the lidar sensor(s) may decrease down a degree (or other increment) and similarly scan from left to right. The lidar sensor(s) may repeat this scanning pattern until, for example, a field of view of the lidar sensor is scanned. The field of view may cover, for example, an area surrounding the mining machine, a portion of the area surrounding the mining machine and generally in front of the lidar sensor, or another area.

Accordingly, by performing the scanning, the lidar sensor(s) may collect data for mapping out an area monitored by the lidar sensor(s). As one example, the detected obstacle may be 15 feet away from the lidar sensor at an angle of 25 degrees to the left and 15 degrees up (as a three-dimensional position). As described in greater detail below, the electronic processor 400 may translate a position of the obstacle to a three-dimensional graph where a reference point of the mining machine 302 (or a camera 315 thereof) is the origin (0, 0, 0), rather than where a center point of the lidar sensor (the proximity sensor 310) is the origin. Although not shown, in some embodiments, the lidar sensor includes a light pulse generator to emit light pulses, a light sensor to detected reflected light pulses received by the lidar sensor, a processor to control the light pulse generator and to receive output from the light sensor indicative of detected light pulses, a memory for storing software executed by the processor to implement the functionality thereof, and a communication interface to enable the processor to communicate sensor data to the controller 305.

FIG. 4B illustrates one embodiment of the camera 315 in further detail. The camera 315 includes a camera processor 450 (for example, a microprocessor, an application specific integrated circuit, or another suitable electronic device), a camera memory 455 (for example, one or more non-transitory computer-readable storage mediums), and a camera communication interface 460. The camera 315 further includes an image sensor 465, a zoom actuator 470, a pan actuator 475, and a tilt actuator 480. The camera processor 450, camera memory 455, communication interface 460, image sensor 465, zoom actuator 470, pan actuator 475, and tilt actuator 480 communicate over one or more data connections or buses, or a combination thereof. The camera 315 illustrated in FIG. 4B represents one example, and, in some embodiments, the camera 315 includes fewer, additional, or different components in different configurations than illustrated in FIG. 4A. Also, in some embodiments, the camera 315 performs functionality in addition to the functionality described herein.

The communication interface 460 allows the camera 315 to communicate with devices external to the camera 315, including the controller 305. The camera processor 450 is configured to access and execute computer-readable instructions (“software”) stored in the memory 455. The software may include firmware, one or more applications, program data, filters, rules, one or more program modules, and other executable instructions. For example, the software may include instructions and associated data for performing a set of functions, including the methods described herein.

The camera 315 collects image data with respect to an area or surrounding of the mining machine 302 using the image sensor 465. More particularly, a lens assembly 485 provides an image to the image sensor 465, which captures the image as image data and provides the image data to the camera processor 450 for storage in the camera memory 455, transmission to the controller 305, or both. Image data may include, for example, a still image, a video stream, and the like.

The camera 315, as illustrated, is a pan, tilt, zoom (PTZ) camera 315. The camera processor 450 is configured to control the zoom actuator 470 to adjust the lens assembly (for example, a linear position of one or more lenses 487 of the lens assembly) to adjust a zoom amount of the lens assembly 485 camera 315. In some embodiments, the zoom actuator 470 is also controlled to adjust a focus of the lens assembly 485. For example, the zoom actuator 470 may include a zoom motor that drives a gearing assembly to adjust the lens assembly 485.

The camera processor 450 is further configured to control the pan actuator 475 to adjust a pan parameter of the camera 315. For example, the pan actuator 475 may include a pan motor that drives a pan assembly 490 (for example, including on or more gears) to swivel the camera 315 (and lens assembly 485) relative to a mount of the camera 315 to pan left or pan right, adjusting the field of view of the camera 315 to shift left or right (horizontally). The camera processor 450 is further configured to control the tilt actuator 480 to adjust a tilt parameter of the camera 315. For example, the tilt actuator 480 may include a tilt motor that drives a tilt assembly 495 (e.g., including on or more gears) to rotate the camera 315 (and lens assembly 485) relative to a mount of the camera 315 to tilt up or tilt down, adjusting the field of view of the camera 315 to shift up or down (vertically). In some embodiments, the camera processor 450 is further configured to communicate with an image processing unit located in the camera memory 455. The image processing unit may include instructions to process the image data.

In some embodiments, the camera 315 receives one or more control signals from the controller 305 (for example, the electronic processor 400). Alternatively, or in addition, in some embodiments, the camera 315 receives one or more control signals from another component of the system 300, such as manual control signals from an operator of the mining machine 302. Based on the one or more control signals, the camera 315 may adjust a pan parameter, a tilt parameter, a zoom parameter, or a combination thereof, as described above. Although the camera 315 in FIG. 4B is illustrated as a PTZ camera, in some embodiments, one or more of the cameras 315 may be configured to adjust fewer than all three pan, tilt, and zoom parameters. For example, in some embodiments, the camera 315 is a pan and tilt camera able to adjust pan and tilt based on control signals, but unable to adjust zoom. In some embodiments the camera 315 is a fixed field camera that maintains a position and captures a consistent field of view.

The cameras 315 may be positioned on (or mounted to) the mining machine 302 at various positions or locations on the mining machine 302, positioned external to the mining machine 302 at various positions or locations around the mining machine 302, or a combination thereof. In some embodiments, each of the cameras 315 are associated with one or more of the sensors 310. As one example, a sensor 310 may be mounted at a first position on the mining machine 302 and a camera may be mounted on the mining machine 302 at (or nearby) the first position.

As seen in FIG. 3, the system 300 also includes the HMI 320. The HMI 320 may include one or more input devices, one or more output devices, or a combination thereof. In some embodiments, the HMI 320 allows a user or operator to interact with (for example, provide input to and receive output from) the mining machine 302. As one example, an operator may interact with the mining machine 302 to control or monitor the mining machine 302 (via one or more control mechanisms of the HMI 320). The HMI 320 may include, for example, a keyboard, a cursor-control device (for example, a mouse), a touch screen, a joy stick, a scroll ball, a control mechanism (for example, one or more mechanical knobs, dials, switches, or buttons), a display device, a printer, a speaker, a microphone, or a combination thereof. As illustrated in FIG. 3, in some embodiments, the HMI 320 includes a display device 350. The display device 350 may be, for example, one or more of a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, or the like. The display device 350 may be located within the operator cab of the mining machine 302 (for example, the operator cab 25 of the drill 10 (FIG. 1) or the operator cab 120 of the rope shovel 100 (FIG. 2)). The HMI 320 (via, for example, the display device 350) may be configured to display conditions or data associated with the mining machine 302 in real-time or substantially real-time. For example, the HMI 320 is configured to display measured electrical characteristics of the mining machine 302, a status of the mining machine 302, an image or video stream of an area or surrounding of the mining machine 302, and the like. In some embodiments, the HMI 320 is configured to display a video feed that includes the image data. The HMI 320 may display multiple video feeds at once from multiple cameras or may flip between multiple video feeds from multiple cameras depending on which camera captures an obstacle.

The actuation devices 340 are configured to receive control signals (for example, from the controller 305, from an operator via one or more control mechanisms of the HMI 320, or the like) to control, for example, hoisting, crowding, and swinging operations of the mining machine 302. Accordingly, the activation devices 340 may include, for example, a motor, a hydraulic cylinder, a pump, and the like.

The machine communication interface 335 allows one or more components of the system 300 to communicate with devices external to the system 300 and/or the mining machine 302. For example, one or more components of the system 300, such as the controller 305, may communicate with one or more remote devices located or positioned external to the mining machine 302 through the machine communication interface 335. The machine communication interface 335 may include a port for receiving a wired connection to an external device (for example, a USB cable and the like), a transceiver for establishing a wireless connection to an external device (for example, over one or more communication networks, such as the Internet, LAN, a WAN, and the like), or a combination thereof. As one example, the controller 305 may communicate with a remote device or system (via the machine communication interface 335) as part of a remote control system or monitoring system of the mining machine 302, such that a remote operator may control or monitor the mining machine 302 from a remote location.

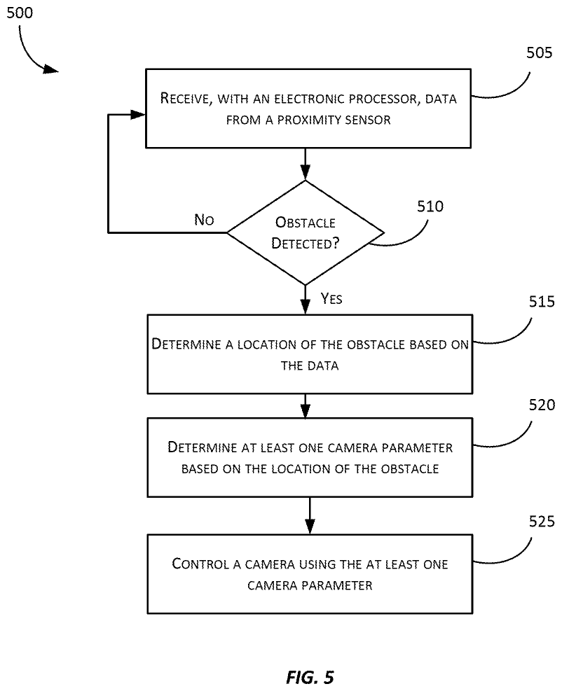

FIG. 5 is a flowchart illustrating a method 500 for providing automated camera control for the mining machine 302 performed by the system 300 according to some embodiments. The method 500 is described as being performed by the controller 305 and, in particular, the obstacle tracking application 420 as executed by the electronic processor 400. However, as noted above, the functionality described with respect to the method 500 may be performed by another device or devices, such as one or more remote devices located external to the mining machine 302.

As illustrated in FIG. 5, the method 500 includes receiving, with the electronic processor 400, data from the proximity sensor 310 (at block 505). The electronic processor 400 receives the data from the proximity sensor 310 via the communication interface 410 of the controller 305. As noted above, the data received from the proximity sensor 310 is associated with an area surrounding the mining machine 302. The area surrounding the mining machine 302 may include a rear surrounding of the mining machine 302, a front surrounding of the mining machine 302, one or more side portion surroundings of the mining machine 302, another surrounding of the mining machine 302, or a combination thereof.

In response to receiving the data from the proximity sensor 310 (at block 505), the electronic processor 400 determines whether one or more obstacles are detected within a vicinity of the mining machine 302 (at block 510). In some embodiments, the electronic processor 400 determines whether an obstacle is detected within the vicinity of the mining machine 302 based on the data received from the proximity sensor 310. As one example, when the proximity sensor 310 is a lidar sensor, the electronic processor 400 may determine that an obstacle is detected within the vicinity of the mining machine 302 when the data indicates that the proximity sensor 310 received light pulses reflected back from a surface (i.e., a surface of the obstacle). As another example, when the proximity sensor 310 is a lidar sensor, the electronic processor 400 may determine that an obstacle is not detected within the vicinity of the mining machine 302 when the data indicates that the proximity sensor 310 did not receive light pulses reflected back from a surface (i.e., a surface of the obstacle). Accordingly, in some embodiments, the electronic processor 400 determines whether an obstacle is within the vicinity of the mining machine 302 based on whether the data received from the proximity sensor 310 indicates that the proximity sensor 310 received reflected light (or a reflection). As yet another example, when the proximity sensor 310 is a camera, the electronic processor 400 may determine that an obstacle is detected within the vicinity of the mining machine 302 when image data indicates that an obstacle is in the field of view of the camera (for example, via image processing).

Alternatively or in addition, in some embodiments, the controller 305 (and one or more additional components of the system 300) is configured to implement a proximity detection system (“PDS”) or an obstacle detection systems (“ODS”) that uses, for example, the proximity sensors 310 to detect objects in proximity to the mining machine 302. An example of a PDS that may be used to detect an object in proximity to the mining machine 302 is described in U.S. Pat. No. 8,768,583, issued Jul. 1, 2014 and entitled “COLLISION DETECTION AND MITIGATION SYSTEMS AND METHODS FOR A SHOVEL,” the entire content of which is hereby incorporated by reference.

As seen in FIG. 5, when no obstacle is detected within the vicinity of the mining machine 302 (No at block 510), the method 500 returns to block 505. Accordingly, in some embodiments, the electronic processor 400 continuously receives data from the proximity sensor 310 and monitors the data for an obstacle within the vicinity of the mining machine 302.

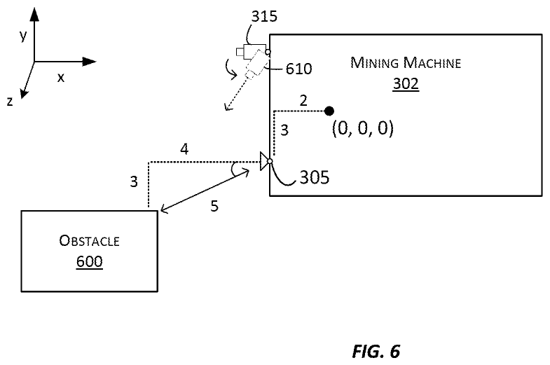

When an obstacle is detected within the vicinity of the mining machine 302 (Yes at block 510), the electronic processor 400 determines a location of the obstacle (at block 515). In some embodiments, the electronic processor 400 determines the location of the object based on the data received from the proximity sensor 310. In some embodiments, the data received from the proximity sensor 310 includes a distance between the obstacle and the proximity sensor 310, a horizontal angle between the obstacle and the proximity sensor 310, a vertical angle between the obstacle and the proximity sensor 310, or a combination thereof. For example, FIG. 6 illustrates an obstacle 600 within a vicinity of the mining machine 302. In the illustrated example, the proximity senor 310 detects the obstacle 600 is 5 meters (m) away from the proximity sensor 310 (as the distance) at an angle of 36.8 degrees to the left of the proximity sensor 310 (as the horizontal angle) and at a height equal to the height of the proximity sensor 310 (as the vertical angle). In some embodiments, the proximity sensor 310 translates the horizontal angle, the vertical angle, or a combination thereof to Cartesian coordinates (x, y, z) with the proximity sensor 310 as the origin (0, 0, 0). Accordingly, as seen in FIG. 6, the Cartesian coordinates describing the horizontal angle and the vertical angle of the obstacle 600 is (−4, −3, 0), with respect to an origin of the proximity sensor 310.

In some embodiments, the electronic processor 400 accesses a coordinate machine map for the mining machine 302 (for example, a three-dimensional Cartesian graph). The coordinate machine map may be stored in the memory 405, where the origin of the coordinate machine map may be selected, for example, as a central point within the mining machine 302, as seen in FIG. 6. In some embodiments, each of the proximity sensors 310, the cameras 315, or a combination may be defined or represented as coordinates on the coordinate machine map (for example, three-dimensional coordinates or two-dimensional coordinates). Based on the coordinates for each of the proximity sensors 310, the cameras 315, or a combination thereof, the electronic processor 400 may determine a location of each of the proximity sensors 310, the cameras 315, or a combination thereof. Following the example illustrated in FIG. 6, the electronic processor 400 may determine that a location of the proximity sensor 310 is two meters to the left and three meters down from the origin (0, 0, 0) of the mining machine 302. In other words, the location of the proximity sensor 310 may be represented or defined by (−2, −3, 0). By knowing the location of the proximity sensor 310, the electronic processor 400 may determine the location of the obstacle 600 with respect to the origin of the mining machine 302. Following the example illustrated in FIG. 6, the electronic processor 400 may determine the location of the obstacle 600 with respect to the origin of the mining machine 302 by adding the offsets of the proximity sensor 310 to the determined object position with respect to the origin of the proximity sensor 310. Accordingly, the electronic processor 400 may determine the location of the obstacle 600 (with respect to the origin of the mining machine 302) to be represented or defined by (−6, −6, 0). Although, in the example illustrated in FIG. 6, the height (i.e., value on the z-axis) of the obstacle 600, the proximity sensor 310, and the origin of the mining machine 302 are presumed to be equal, this presumption is made to simplify the discussion. In some embodiments, the height of one or more of these elements is different from one or more of the other elements.

After determining the location of the obstacle based on the data received from the sensor 310 (at block 515), the electronic processor 400 determines at least one camera parameter based on the location of the obstacle (at block 520). The at least one camera parameter is determined such that the obstacle is positioned within a field of view of the camera 315. In some embodiments, the camera parameters include a pan parameter, a tilt parameter, a zoom parameter, another camera parameter, or a combination thereof.

The pan parameter may be, for example, a value indicative of a swivel angle for the camera 315 ranging between 0-360 degrees, 0-180 degrees, 0-90 degrees, or another range. The electronic processor 400 may control the pan actuator 475 to adjust the pan assembly 490 to achieve the desired swivel angle of the camera 315 causing a shift of the field of view of the camera 315 left or right to direct the camera 315 to the obstacle. The control of the pan actuator 475 may be open loop control or, in some embodiments, a position sensor for the pan actuator 475 is provided to enable closed loop control. The tilt parameter may be, for example, a value indicative of a tilt angle for the camera 315 ranging between 0-360 degrees, 0-180 degrees, 0-90 degrees, or another range. The electronic processor 400 may control the tilt actuator 480 to adjust the tilt assembly 495 to achieve the desired tilt angle of the camera 315 causing a shift of the field of view of the camera 315 up or down to direct the camera 315 to the obstacle. The control of the tilt actuator 480 may be open loop control or, in some embodiments, a position sensor for the pan actuator 480 is provided to enable closed loop control. The zoom parameter may be, for example, a value indicative of a zoom amount for the camera 315 ranging from a minimum (no) zoom to maximum zoom. The electronic processor 400 may control the zoom actuator 470 to adjust the lens assembly 485 to achieve the desired zoom amount of the camera 315 causing a zoom of the field of view of the camera 315 in or out to direct the camera 315 to the obstacle. The control of the zoom actuator 470 may be open loop control or, in some embodiments, a position sensor for the zoom actuator 470 is provided to enable closed loop control. Another camera parameter may include the electronic processor 400 instructing the camera 315 to capture image data to be displayed on a video feed.

Returning to the example of FIG. 6, the electronic processor 400 may determine, as a result of method block 520, that the pan parameter is 210 degrees, where the y-axis is parallel with a 0 degree direction and the camera 315 initially has a pan parameter of 270 degrees. In some embodiments, rather than an absolute value relative to a fixed reference point, the pan parameter is a relative value (for example, −60 degrees, in the example of FIG. 6). To calculate the pan parameter, the electronic processor 400 uses the known position of the camera and the known position of the obstacle (for example, on the common coordinate machine map) and calculates an angle between the two positions with respect to the y-axis, using geometric principles, resulting in the swivel angle that will direct the camera 315 and its lens assembly 485 towards the obstacle. The tilt parameter may be calculated by the electronic processor 400 using similar techniques, except in the vertical plane rather than horizontal plane. The zoom parameter may be calculated as a function of a distance to the obstacle 600, the size of the obstacle 600, or a combination thereof. For example, the further the distance and the smaller the obstacle 600, the more the camera 315 may zoom in. The particular relationship between distance and size of the obstacle to the zoom parameter may be defined, for example, in a lookup table or equation stored in a memory of the memory 405.

The electronic processor 400 then controls the camera 315 using the at least one camera parameter (at block 525). The electronic processor 400 may control the camera 315 by generating and transmitting one or more control signals to the camera 315. In response to receiving the control signal(s), the camera 315 may set a pan parameter, a tilt parameter, a zoom parameter, another camera parameter, or a combination thereof based on the control signal(s). In some embodiments, the electronic processor 400 automatically controls (i.e., without manual intervention by an operator) the camera 315 using the at least one camera parameter. For example, with reference to FIG. 6, the camera 315 is panned to its left to a second position 610 having a pan angle of approximately 210 degrees with respect to the y-axis. In the second position 610, the obstacle 600 is in the field of view of the camera 315. As another example, in some embodiments, the electronic processor 400 may control the one or more cameras 315 by switching from a first camera to a second camera of the one or more cameras 315 and instruct the second camera to capture image data for a video feed.

Accordingly, by controlling the camera 315 using the at least one camera parameter, the obstacle is positioned within a field of view of the camera 315. When the obstacle is in the field of view of the camera 315, the camera 315 collects or captures image data (or a video feed). The image data collected by the camera 315 may be provided or displayed to, for example, an operator of the mining machine 302. In some embodiments, the camera 315 transmits the image data to the HMI 320 for display to an operator (via, for example, the display device 350 of the HMI 320) within an operator cab of the mining machine 302. Alternatively or in addition, in some embodiments, the camera 315 transmits the image data to a remote device or system (via the machine communication interface 335) as part of a remote control system or monitoring system of the mining machine 302, such that a remote operator may control or monitor the mining machine 302 from a remote location.

In some embodiments, the electronic processor 400 continuously monitors or tracks a location or position of the detected obstacle (based on the data received from one or more of the proximity sensors 310). Accordingly, in such embodiments, the electronic processor 400 continuously (for example, repeatedly over a period of time) receives data from one or more of the proximity sensors 310. In response to detecting a change in location or position (based on new or updated data received from one or more of the proximity sensors 310), the electronic processor 400 may repeat blocks 515-525. As one example, when the electronic processor 400 determines that the detected obstacle object changed position (due to movement of the obstacle and/or the mining machine 302), the electronic processor 400 may determine an updated or new location (for example, a second location) of the obstacle based on new data received from the proximity sensor 310 (as similarly described above with respect to block 515). After determining the updated or new location of the obstacle, the electronic processor 400 determines an updated or new camera parameter(s) (for example, a second at least one camera parameter) based on the updated or new location of the obstacle (as similarly described above with respect to block 520). The electronic processor 400 may then automatically control the camera 315 using the updated or new camera parameter(s) (as similarly described above with respect to block 525).

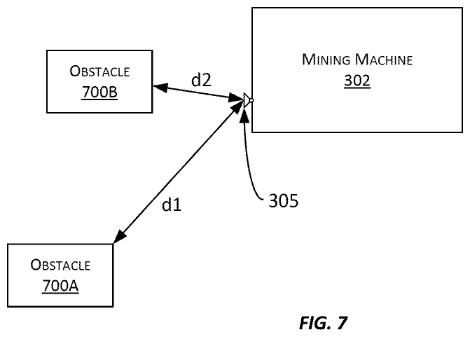

Alternatively, or in addition, in some embodiments, the electronic processor 400 may detect more than one obstacle within the vicinity of the mining machine 302. In such embodiments, the electronic processor 400 may determine a position for each of the obstacles detected within the vicinity of the mining machine 302. As one example, the electronic processor 400 may determine a first position for a first obstacle and a second position for a second obstacle. After determining a location for each of the obstacles (as similarly described above with respect to block 515), the electronic processor 400 may determine a priority for each of the obstacles. A priority may represent a risk level. As one example, a high priority may correspond to a high collision risk. Accordingly, in some embodiments, the electronic processor 400 determines the priority for each of the obstacles based on a distance between each obstacle and the mining machine 302. For example, in such embodiments, the electronic processor 400 may determine that the obstacle that is closest to the mining machine 302 has the highest priority. The electronic processor 400 may then proceed with the method 500 (for example, blocks 520-525) with respect to the object with the highest priority. FIG. 7 illustrates a top view of the mining machine 302 with a first obstacle 700A and a second obstacle 700B within the vicinity of the mining machine 302. As seen in FIG. 7, the distance (a first distance) between the first obstacle 700A and the proximity sensor 310 is represented by “d1” and the distance (a second distance) between the second obstacle 700B and the proximity sensor 310 is represented by “d2.” According to the example illustrated in FIG. 7, the electronic processor 400 may determine that the second obstacle 700B is a higher priority because the second obstacle 700B is closer to the mining machine 302 than the first obstacle 700B (for example, d2 is less than d1). Accordingly, the electronic processor 400 may then determine one or more camera parameters based on the location of the second obstacle 700B and control the camera 315 using the at least one camera parameter to direct a field of view of the camera 315 to the second obstacle 700B.

In some embodiments, the mining machine 302 includes multiple cameras 315, each associated with a different surrounding area in the vicinity of the mining machine 302 and each associated with a separate display monitor of the display device 350 of the HMI 320. In such embodiments, the method 500 may be executed for each camera-display pair such that each camera 315 may be controlled to capture images of and display a separate obstacle detected in the vicinity of the mining machine 302. For example, the electronic processor 400 may detect a first location of first obstacle with a first proximity sensor 310 and detect a second location of a second obstacle with a second proximity sensor 310. The electronic processor 400 may then control one or more camera parameters of a first camera 315 to direct the field of view of the first camera 315 to the first obstacle and to control one or more camera parameters of a second camera 315 to direct the field of view of the second camera 315 to the second obstacle. Then, the image data from the first camera 315 may be displayed on a first display monitor of the display device 350 and the image data from the second camera 315 may be displayed on a second display monitor of the display device 350. Alternatively, or in addition, the display device 350 includes a single display monitor. In such embodiments, the display device 350 may display a selected camera feed, a split image on the display monitor (e.g., showing two or more camera feeds, each feed in a respective section of the split image), or the like. Additionally, in some embodiments, the display device 350 automatically changes the camera feed being displayed based on a priority setting, based on which camera feed includes the detected obstacle, is closed to the detected obstacle, or the like.

In some embodiments, the camera feed includes a visual representation overlaid on the camera feed. As one example, the field of view of the camera may be blocked from including the detected obstacle, such as by a cab of the mining machine 302. When the field of view of the camera is blocked, the electronic processor 400 may generate a visual representation of the detected obstacle and overlay the visual representation on the camera feed such that the visual representation represents the detected obstacle (for example, in size, location, and the like). In some embodiments, the visual representation may be a simple icon or may be a display box representing an outline or border of the detected obstacle (for example, a display box around an area in which the detected obstacle would be).

Accordingly, embodiments described herein provide systems and methods for detecting objects in the vicinity of a mining machine and providing automated camera control for object tracking.

What is claimed is:

1. A system for detecting an obstacle within a vicinity of a mining machine and providing automated camera control, the system comprising:
at least one proximity sensor associated with the mining machine;
a camera associated with the mining machine; and
an electronic processor communicatively coupled to the at least one proximity sensor and the camera, the electronic processor configured to
receive data from the at least one proximity sensor,
determine a location of at least one obstacle based on the data,
determine at least one camera parameter based on the location of the at least one obstacle, and
control the camera using the at least one camera parameter to maintain the at least one obstacle within a field of view of the camera.

2. The system of claim 1, wherein the at least one proximity sensor and the camera are configured to be mounted to an exterior of the mining machine.

3. The system of claim 1, wherein the at least one proximity sensor includes at least one selected from the group consisting of a lidar sensor, a radar sensor, and a second camera.

4. The system of claim 3, wherein the camera may be either a pan, tilt camera or a fixed view camera, and wherein the second camera may be either a pan, tilt camera or a fixed view camera.

5. The system of claim 1, wherein the electronic processor is configured to detect a change in location of the at least one obstacle.

6. The system of claim 5, wherein, in response to detecting the change in location of the at least one obstacle, the electronic processor is configured to
determine an updated location of the at least one obstacle,
determine at least one updated camera parameter based on the updated location, and
control the camera using the at least one updated camera parameter, wherein the at least one updated camera parameter maintains the at least one obstacle within a field of view of the camera.

7. The system of claim 1, further comprising a display device associated with the mining machine, and
wherein the electronic processor is further configured to display a video feed from the camera on the display device.

8. The system of claim 7, wherein controlling the camera using the at least one camera parameter includes controlling at least one selected from a group consisting of a pan parameter, a tilt parameter, a zoom parameter, and a crop parameter.

9. The system of claim 7, wherein controlling the camera using the at least one camera parameter includes at least one of mechanically controlling the camera and electronically processing the camera image to adjust the video feed of the camera.

10. The system of claim 1,
wherein, to determine the location of the at least one obstacle, the electronic processor is configured to determine a first location of a first obstacle, and determine a second location of a second obstacle,
wherein the electronic processor is further configured to determine whether the first obstacle or the second obstacle is closest to the mining machine by comparing the first location and the second location, and
wherein, to determine the at least one camera parameter based on the location of the at least one obstacle, the electronic processor is configured to
determine that the first obstacle is closest to the mining machine, and
determine the at least one camera parameter based on the first location of the first obstacle in response to determining that the first obstacle is closest to the mining machine.

11. The system of claim 1, wherein the electronic processor is configured to:
continuously determine the location of the at least one obstacle as the obstacle moves relative to the mining machine,
continuously determine one or more updated camera parameters based on the location as continuously determined, and
continuously control the camera using the one or more updated camera parameters based on the location of the at least one obstacle.

12. The system of claim 11, wherein the one or more updated camera parameters maintains the at least one obstacle within a field of view of the camera.

13. A method for detecting an obstacle within a vicinity of a mining machine and providing automated camera control, the method comprising:
receiving, with an electronic processor, data from a proximity sensor;
determining, with the electronic processor, a location of the at least one obstacle based on the data received from the proximity sensor;
determining, with the electronic processor, at least one camera parameter based on the location of the at least one obstacle; and
controlling, with the electronic processor, a camera associated with the mining machine using the at least one camera parameter to maintain the at least one obstacle within a field of view of the camera.

14. The method of claim 13, wherein receiving data from a proximity sensor includes receiving data from at least one selected from the group consisting of a lidar sensor, a radar sensor, and a second camera.

15. The method of claim 14, wherein the camera may be either a pan, tilt camera or a fixed view camera, and wherein the second camera may be either a pan, tilt camera or a fixed view camera.

16. The method of claim 13, wherein receiving the data from the proximity sensor includes receiving at least one selected from a group consisting of a distance between the at least one obstacle and the proximity sensor, a horizontal angle between the at least one obstacle and the proximity sensor, and a vertical angle between the at least one obstacle and the proximity sensor.

17. The method of claim 13, further comprising:
in response to detecting a change in location of the at least one obstacle
determining an updated location of the at least one obstacle,
determining at least one updated camera parameter based on the updated location, and
controlling the camera using the at least one updated camera parameter.

18. The method of claim 17, wherein determining the at least one updated camera parameter includes determining an updated set of camera parameters that maintains the at least one obstacle within a field of view of the camera.

19. The method of claim 13, wherein determining the at least one updated camera parameter includes determining at least one selected from a group consisting of a pan parameter, a tilt parameter, a zoom parameter, and a crop parameter.

20. The method of claim 13, further comprising enabling display of a video feed from the camera on a video monitor associated with the mining machine.

21. The method of claim 20, wherein controlling the camera using the at least one camera parameter includes at least one of mechanically controlling the camera and electronically processing the camera image to adjust the video feed of the camera.

22. The method of claim 13, further comprising:
continuously determining the location of the at least one obstacle as the obstacle moves relative to the mining machine;
continuously determining one or more updated camera parameters based on the location as continuously determined; and
continuously controlling the camera using the one or more updated camera parameters based on the location of the at least one obstacle.

23. The method of claim 22, wherein continuously controlling the camera using the one or more updated camera parameters maintains the at least one obstacle within a field of view of the camera.

24. The method of claim 13,
wherein determining the location of the at least one obstacle includes
determining a first location of a first obstacle,
determining a second location of a second obstacle,
determining whether the first obstacle or the second obstacle is closest to the mining machine by comparing the first location and the second location, and
wherein determining the at least one camera parameter based on the location of the at least one obstacle includes
determining that the first obstacle is closest to the mining machine, and
determining the at least one camera parameter based on the first location of the first obstacle in response to determining that the first obstacle is closest to the mining machine.

25. A system for detecting an obstacle within a vicinity of a mining machine and providing automated camera control, the system comprising:
at least one camera associated with the mining machine, the camera configured to sense obstacles located near the mining machine; and
an electronic processor communicatively coupled to the at least one camera, the electronic processor configured to
receive data from the at least one camera,
determine a location of at least one obstacle based on the data,
determine at least one camera parameter based on the location of the at least one obstacle, and
control the at least one camera using the at least one camera parameter to maintain the at least one obstacle within a field of view of the camera.

26. The system of claim 25, further comprising a display device associated with the mining machine, and
wherein the electronic processor is further configured to display a video feed from the at least one camera on the display device.

27. The system of claim 26, wherein the at least one camera includes a first camera configured to sense obstacles located near the mining machine and a second camera configured to display a video feed on the display device.

28. The system of claim 27, wherein the first camera may be either a pan, tilt camera or a fixed view camera, and wherein the second camera may be either a pan, tilt camera or a fixed view camera.

29. The system of claim 25, wherein controlling the at least one camera using the at least one camera parameter includes controlling at least one selected from a group consisting of a pan parameter, a tilt parameter, a zoom parameter, and a crop parameter.

30. The system of claim 25, wherein controlling the at least one camera includes at least one of mechanically controlling the at least one camera and electronically processing the camera image to adjust the video feed of the at least one camera.

31. A system for detecting an obstacle within a vicinity of a mining machine and providing automated camera control, the system comprising:
at least one proximity sensor associated with the mining machine;
a first camera and a second camera associated with the mining machine; and
an electronic processor communicatively coupled to the at least one proximity sensor, the first camera and the second camera, the electronic processor configured to
receive data from the at least one proximity sensor,
determine a location of at least one obstacle based on the data,
determine that the location of the at least one obstacle is in a field of view of the first camera, and
provide, in response to determining that the location of the at least one obstacle is in the field of view of the first camera, video feed from the first camera on a display device associated with the mining machine.

32. The system of claim 31, wherein the electronic processor is further configured to:
determine that the location of the at least one obstacle is in a field of view of the second camera, and
switch the video feed from the first camera to the second camera.
